(19) United States
(12) Patent Application Publication
(10) Pub. No.: US 2026/0222835 A1
(43) Pub. Date: Jul. 30, 2026

(54) METHOD FOR ISOLATION GROUP SELECTION DURING SLICE PROVISIONING

(71) Applicant: Nokia Technologies Oy, Espoo (FI)

(72) Inventors: Srilakshmi SRINIVASARAJU, Bangalore (IN); Shu Qiang SUN, Chengdu (CN); Jing PING, Chengdu (CN)

(21) Appl. No.: 19/141,200

(22) PCT Filed: Dec. 22, 2022
(86) PCT No.: PCT/CN2022/140918

§ 371 Date: Jun. 19, 2025

(51) Int. Cl. H04W 24/02; H04W 48/18; H04W 72/044

(52) U.S. Cl. CPC H04W 24/02; H04W 48/18; H04W 72/044

(57) ABSTRACT

There is provided an apparatus (202, 302) comprising: means for receiving a request to create or update a network slice, wherein the request comprises a selection list; means for determining an isolation group using the selection list; and means for providing a network slice instance for the network slice request, wherein the determined isolation group is associated with the network slice instance.

### FIELD

The present application relates to a method, apparatus, system and computer program and in particular but not exclusively to apparatus, methods and computer programs for isolation group selection during slice provisioning.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

A feature of modern communication systems is known as network slicing. Network slicing is a feature that enables multiplexing of virtualized and/or independent logical networks on a physical network infrastructure.

### SUMMARY

According to a first aspect there is disclosed an apparatus comprising: means for receiving a request to create or update a network slice, wherein the request comprises a selection list; means for determining an isolation group using the selection list; and means for providing a network slice instance for the network slice request, wherein the determined isolation group is associated with the network slice instance.

According to some examples the selection list comprises a scope that a slice consumer can specify for the determination of the isolation group.

According to some examples the scope that the slice consumer can specify comprises at least one isolation selection type and at least one isolation selection value. For example, a type(s) indicated by the isolation selection type may include at least one of: a group type; a group name; a group type identifier; an identifier; an isolation level. For example, the isolation selection value may indicate a value which corresponds to the type(s) specified in the isolation selection type.

According to some examples, the apparatus comprises means for checking an isolation selection type and an isolation selection value of at least one of first and second items in the selection list.

According to some examples, the apparatus comprises means for pre-configuring isolation groups in the apparatus.

According to some examples, the means for pre-configuring isolation groups in the apparatus comprises means for creating isolation groups in the apparatus based on information from a network operator.

According to some examples, the apparatus comprises means for allocating resources for the network slice instance based on an isolation profile of the determined isolation group. For example, the resources may be allocated for one or more of: management data; resources.

According to some examples, the means for determining the isolation group comprises a means for selecting a pre-configured isolation group or a means for creating an isolation group.

According to some examples, the means for providing the network slice instance comprises a means for creating a network slice instance or a means for updating a network slice instance.

According to some examples, the isolation group comprises a group of network slices with the same isolation requirements for management and managed resources.

According to some examples, the apparatus further comprises: means for translating the received selection list to a slice profile selection list for at least one of a radio access network (RAN), a core network (CN) and a transport network (TN); means for transmitting the slice profile selection list to at least one of a RAN network slice subnet provider, CN network slice subnet provider and TN network slice subnet provider, wherein at least one of the RAN network slice subnet provider, CN network slice subnet provider and TN network slice subnet provider uses the received slice profile selection list to determine an isolation group; and means for receiving information of a network slice subnet instance from at least one of the RAN network slice subnet provider, CN network slice subnet provider and TN network slice subnet provider, wherein the network subnet slice instance is associated with the determined isolation group.

According to some examples, the apparatus may comprise a Network Service Provider (NSP); a Network Slice Management Service Provider (NSMS_P); a Network Slice Subnet Provider (NSSP); a Network Slice Subnet Management Service Provider (NSSMS_P).

According to some examples, the network slice comprises a full network slice or a network slice subnet.

According to some examples, the network slice instance comprises a network slice instance or a network slice subnet instance.

According to some examples, the means comprises at least one processor; and at least one memory including computer program code, the at least one memory and computer program code configured to, with the at least one processor, cause the performance of the apparatus.

According to a second aspect there is provided an apparatus comprising at least one processor; and at least one memory storing instructions that, when executed by the at least one processor, cause the apparatus at least to perform: receiving a request to create or update a network slice, wherein the request comprises a selection list; determining an isolation group using the selection list; and providing a network slice instance for the network slice request, wherein the determined isolation group is associated with the network slice instance.

According to a third aspect there is provided an apparatus comprising: means for transmitting a request to create or update a network slice, wherein the request comprises a selection list, and wherein the selection list comprises a scope that the apparatus can specify for the determination of an isolation group, the scope comprising at least one isolation selection type and at least one isolation selection value; and means for receiving information of a network slice instance, wherein the network slice instance is associated with a determined isolation group.

According to some examples, a type(s) indicated by the isolation selection type may include at least one of: a group type; a group name; a group type identifier; an identifier; an isolation level. According to some examples, the isolation selection value may indicate a value which corresponds to the type(s) specified in the isolation selection type.

According to some examples, the isolation group comprises a group of network slices with the same isolation requirements for management and managed resources.

According to some examples, the apparatus may comprise a Network Slice Consumer (NSC); a Network Slice Management Service Consumer (NSMS_C); a Network Slice Subnet Consumer (NSSC); a Network Slice Subnet Management Service Consumer (NSSMS_C).

According to some examples, the network slice comprises a full network slice or a network slice subnet.

According to some examples, the network slice instance comprises a network slice instance or a network slice subnet instance.

According to some examples, the means comprises at least one processor; and at least one memory including computer program code, the at least one memory and computer program code configured to, with the at least one processor, cause the performance of the apparatus.

According to a fourth aspect there is provided an apparatus comprising at least one processor; and at least one memory storing instructions that, when executed by the at least one processor, cause the apparatus at least to perform: transmitting a request to create or update a network slice, wherein the request comprises a selection list, and wherein the selection list comprises a scope that the apparatus can specify for the determination of an isolation group, the scope comprising at least one isolation selection type and at least one isolation selection value; and receiving information of a network slice instance, wherein the network slice instance is associated with a determined isolation group.

According to a fifth aspect there is provided a method comprising: receiving a request to create or update a network slice, wherein the request comprises a selection list; determining an isolation group using the selection list; and providing a network slice instance for the network slice request, wherein the determined isolation group is associated with the network slice instance.

According to some examples, the selection list comprises a scope that a slice consumer can specify for the determination of the isolation group.

According to some examples the scope that the slice consumer can specify comprises at least one isolation selection type and at least one isolation selection value. For example a type(s) indicated by the isolation selection type may include at least one of: a group type; a group name; a group type identifier; an identifier; an isolation level. For example, the isolation selection value may indicate a value which corresponds to the type(s) specified in the isolation selection type.

According to some examples, the method comprises checking an isolation selection type and an isolation selection value of at least one of first and second items in the selection list.

According to some examples, the method comprises pre-configuring isolation groups.

According to some examples, pre-configuring isolation groups comprises creating isolation groups based on information from a network operator.

According to some examples, the method comprises allocating resources for the network slice instance based on an isolation profile of the determined isolation group. For example, resources may be allocated for one or more of: management data; resources.

According to some examples, determining the isolation group comprises selecting a pre-configured isolation group or creating an isolation group.

According to some examples, providing the network slice instance comprises creating a network slice instance or updating a network slice instance.

According to some examples, the isolation group comprises a group of network slices with the same isolation requirements for management and managed resources.

According to some examples, the method further comprises: translating the received selection list to a slice profile selection list for at least one of a radio access network (RAN), a core network (CN) and a transport network (TN); transmitting the slice profile selection list to at least one of a RAN network slice subnet provider, CN network slice subnet provider and TN network slice subnet provider, wherein at least one of the RAN network slice subnet provider, CN network slice subnet provider and TN network slice subnet provider uses the received slice profile selection list to determine an isolation group; and receiving information of a network slice subnet instance from at least one of the RAN network slice subnet provider, CN network slice subnet provider and TN network slice subnet provider, wherein the network subnet slice instance is associated with the determined isolation group.

According to some examples, the network slice comprises a full network slice or a network slice subnet.

According to some examples, the network slice instance comprises a network slice instance or a network slice subnet instance.

According to a sixth aspect, there is a provided a method comprising: transmitting a request to create or update a network slice, wherein the request comprises a selection list, and wherein the selection list comprises a scope that can be specified for the determination of an isolation group, the scope comprising at least one isolation selection type and at least one isolation selection value; and receiving information of a network slice instance, wherein the network slice instance is associated with a determined isolation group.

According to some examples, a type(s) indicated by the isolation selection type may include at least one of: a group type; a group name; a group type identifier; an identifier; an isolation level. According to some examples, the isolation selection value may indicate a value which corresponds to the type(s) specified in the isolation selection type.

According to some examples, the isolation group comprises a group of network slices with the same isolation requirements for management and managed resources.

According to some examples, the network slice comprises a full network slice or a network slice subnet.

According to some examples, the network slice instance comprises a network slice instance or a network slice subnet instance.

According to a seventh aspect there is provided a computer program comprising instructions for causing an apparatus to perform at least the following: receiving a request to create or update a network slice, wherein the request comprises a selection list; determining an isolation group using the selection list; and providing a network slice instance for the network slice request, wherein the determined isolation group is associated with the network slice instance.

According to an eighth aspect there is provided a computer program comprising instructions for causing an apparatus perform at least the following: transmitting a request to create or update a network slice, wherein the request comprises a selection list, and wherein the selection list comprises a scope that the apparatus can specify for the determination of an isolation group, the scope comprising at least one isolation selection type and at least one isolation selection value; and receiving information of a network slice instance, wherein the network slice instance is associated with a determined isolation group.

According to a ninth aspect there is provided a computer program comprising instructions stored thereon for performing at least the following: receiving a request to create or update a network slice, wherein the request comprises a selection list; determining an isolation group using the selection list; and providing a network slice instance for the network slice request, wherein the determined isolation group is associated with the network slice instance.

According to a tenth aspect there is provided a computer program comprising instructions stored thereon for performing at least the following: transmitting a request to create or update a network slice, wherein the request comprises a selection list, and wherein the selection list comprises a scope that the apparatus can specify for the determination of an isolation group, the scope comprising at least one isolation selection type and at least one isolation selection value; and receiving information of a network slice instance, wherein the network slice instance is associated with a determined isolation group.

According to an eleventh aspect there is provided a non-transitory computer readable medium comprising program instructions that, when executed by an apparatus, cause the apparatus to perform at least the following: receiving a request to create or update a network slice, wherein the request comprises a selection list; determining an isolation group using the selection list; and providing a network slice instance for the network slice request, wherein the determined isolation group is associated with the network slice instance.

According to a twelfth aspect there is provided a non-transitory computer readable medium comprising program instructions that, when executed by an apparatus, cause the apparatus to perform at least the following: transmitting a request to create or update a network slice, wherein the request comprises a selection list, and wherein the selection list comprises a scope that the apparatus can specify for the determination of an isolation group, the scope comprising at least one isolation selection type and at least one isolation selection value; and receiving information of a network slice instance, wherein the network slice instance is associated with a determined isolation group.

According to a thirteenth aspect there is provided a non-transitory computer readable medium comprising program instructions stored thereon for performing at least the following: receiving a request to create or update a network slice, wherein the request comprises a selection list; determining an isolation group using the selection list; and providing a network slice instance for the network slice request, wherein the determined isolation group is associated with the network slice instance.

According to a fourteenth aspect there is provided a non-transitory computer readable medium comprising program instructions stored thereon for performing at least the following: transmitting a request to create or update a network slice, wherein the request comprises a selection list, and wherein the selection list comprises a scope that the apparatus can specify for the determination of an isolation group, the scope comprising at least one isolation selection type and at least one isolation selection value; and receiving information of a network slice instance, wherein the network slice instance is associated with a determined isolation group.

### DESCRIPTION OF FIGURES

Embodiments will now be described, by way of example only, with reference to the accompanying Figures in which: FIG. 1 shows a schematic representation of a 5G system;

FIG. 2 is a signalling diagram according to an example embodiment;

FIG. 3 is a signalling diagram according to an example embodiment;

FIG. 4 is a flow chart according to an example embodiment;

FIG. 5 shows example isolation groups;

FIG. 6 is a signalling diagram according to an example embodiment;

FIG. 7 is a signalling diagram according to an example embodiment;

FIG. 8 is a signalling diagram according to an example embodiment;

FIG. 9 shows a schematic representation of a control apparatus according to an example embodiment;

FIG. 10 shows a schematic representation of an apparatus according to an example embodiment;

FIG. 11 is a flow chart of a method according to an example embodiment;

FIG. 12 is a flow chart of a method according to an example embodiment;

FIG. 13 shows a schematic representation of a non-volatile memory medium storing instructions which when executed by a processor allow a processor to perform one or more of the steps of the methods of some embodiments.

### DETAILED DESCRIPTION

In the following, certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIG. 1 to assist in understanding the technology underlying the described examples.

FIG. 1 shows a schematic representation of a 5G system (5GS), which is provided by way of example of a communication system. The 5GS may comprise a terminal or user equipment (UE), a 5G radio access network (5GRAN) or next generation radio access network (NG-RAN), a 5G core network (5GC), one or more application function (AF) and one or more data networks.

The 5G-RAN may comprise one or more gNodeB (gNB) or one or more gNodeB (gNB) distributed unit functions connected to one or more gNodeB (gNB) centralized unit functions.

The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

Although a 5G system is shown in FIG. 1 for the purpose of explanation, it will be understood that the present disclosure may also be applied to other systems, such as 4G systems.

As mentioned above, a feature of modern communication systems is known as network slicing. A sliced network can comprise a set of logical networks on top of a shared infrastructure. Each logical network can be designed to serve a defined purpose and may comprise the required network resources, configured and connected end-to-end. Each network slice can, in some examples, be understood as an isolated end-to-end network tailored to fulfil diverse requirements requested by a particular application. Each network slice can be administrated by a network operator (NOP). The network operator can be a mobile network operator or a virtual mobile network operator. Network slicing can be supported in mobile networks designed to efficiently embrace a plethora of services which can have very different service level requirements. In examples, a network slice can be tailored based on requirements in a Service Level Agreement (SLA) agreed between associated services, customers, enterprises or vertical industries.

3GPP TS 28.541 defines a NetworkSlice and NetworkSliceSubnet information object class (IOC). The NetworkSlice IOC includes a ServiceProfile datatype. This datatype represents the properties of network slice related requirements that should be supported by a network slice instance in a 5G network. The network slice related requirements may apply to a one-to-one relationship between a Network Slice Customer (NSC) and a Network Slice Provider (NSP). The ServiceProfile datatype may define a variety of attributes. An existing attribute includes the networkSliceSharingIndicator attribute which specifies whether the instance of the NetworkSlicelnstance object can be shared with other instance(s). The NetworkSliceSubnet IOC includes a SliceProfile datatype, which represents the properties of network slice subnet related requirements that should be supported by a NetworkSliceSubnet instance in a 5G network. The NetworkSliceSubnet can be categorised as RANSliceSubnet, CNSliceSubnet and TopSliceSubnet. The RANSliceSubnet represents the RAN network slice subnet in a 5G network, associated to one or multiple “RANSliceSubnetProfile”. The CNSliceSubnet represents the CN network slice subnet in a 5G network, associated to one or multiple “CNSliceSubnetProfile”. The TopSliceSubnet represents the top network slice subnet in a 5G network, associated to one or multiple “TopSliceSubnetProfile”. SliceProfile datatypes define a variety of attributes. An existing resourceSharingLevel attribute defined in CNSliceSubnetProfile, RANSliceSubnetProfile and TopSliceSubnetProfile is described in 3GPP TS 28.541, which specifies whether the resources to be allocated to the network slice can be shared with other network slice(s).

In some examples, network slices can be isolated. GSMA NG. 127 describes isolation as a feature that can be used in network slicing. A network slice instance (NSI) may be fully or partly, logically and/or physically isolated from another network slice instance. Network slicing allows the concurrent execution of multiple NSIs on top of a common infrastructure, satisfying their individual service Key Performance Indicators while guaranteeing their independence. The use of a single shared infrastructure makes isolation a feature that supports network slicing. Isolation can, in some examples, be considered as the ability of a Network Service Provider (NSP) to ensure that congestion, attacks and life-cycle related events (e.g., scaling in/out) on one NSI does not negatively impact other existing NSIs.

The isolation of network slices can be managed. The isolation of network slices may include isolation of management resources (e.g., data, functions or services) and managed resources (e.g. data, network functions, infrastructure resource, etc.) in multiple domains (e.g. RAN, Core, Transport, etc.). Isolation at multiple layers (E2E Slice/Service, Slice Subnet, Managed Function, etc.) to ensure the expected security level of a network slice may be necessary, in some examples, for a Mobile Network Operator (MNO) to commercially deploy the 5G network. An isolation group may be introduced to gather Network Slices (or other services in various layers) sharing the same resources with or without isolation. An Isolation Group can be defined in each layer of resources forming the E2E Network Slice. For example, there may be Isolation Groups in an E2E slice layer (to group resources of Network Slice Services), a Network Slice Subnet (NSS) layer (to group resources of NSS Services) or a Managed Function (MF) layer (to group resources of MF Services), etc. An Isolation Group can, in examples, be further defined by characters and characteristics (for example, tenant, slice/service type (SST), industry, region, type of IoT devices, etc.). An Isolation Profile may be introduced to define isolation requirements of an Isolation Group. Each Isolation Group can be associated with an Isolation Profile and the Isolation Profile includes an Isolation Level or Isolation Rule, described in more detail below. The Isolation Profile may include isolation policies to isolate and protect the resources assigned to the Isolation Group. The Isolation Profile and isolation polices in different domains (e.g., E2E, RAN, Core, Transport, Virtualization, etc. domains) or different layers (e.g., Network Slice, Slice Subnet, Managed Function, Network Service, VNF, etc.) can be different. The service provider/producer, for example, the Network Slice Provider (NSP), Network Slice Subnet Provider (NSSP) or Managed Function Provider (MFP), may create or select Isolation Group(s) for the Network Slice (or NSS Service, or MF Service) and assign the Isolation Group(s) to the Network Slice (or NSS Service, or MF Service).

GSMA NG.116 (v5.07) defines Isolation Level with the following attributes: Isolation, Physical Isolation and Logical Isolation. These attributes may therefore define the Isolation requirements for a network slice/network slice instance. Table 1 below defines the Isolation Level attributes and the associated allowed values in further detail.

TABLE 1
Isolation Level attributes and the associated allowed values

| Attribute | Allowed Values |
|---|---|
| Isolation | No Isolation |
| | Physical Isolation |
| | Logical Isolation |
| Physical Isolation | Process and threads Isolation |
| | Physical memory Isolation |
| | Physical network Isolation |
| Logical Isolation | Virtual resource Isolation |
| | Network function Isolation |
| | Tenant/Service Isolation |

However, the present disclosure identifies that the above-mentioned proposals do not describe a mechanism for a Network Slice Consumer (NSC) to select or indicate isolation requirements, for example the selection of an Isolation Group by a Network Service Provider (NSP), while requesting a network slice.

Some example embodiments described herein introduce a mechanism to extend datatypes, such as ServiceProfile and SliceProfile datatypes, with additional attribute(s) that can be used by a slice consumer (for example an NSC) and a service producer (for example an NSP) to select an Isolation Group with appropriate isolation requirements, while requesting creation of a network slice. The slice consumer can also use the same attributes to request association or modification of Isolation Groups, and hence isolation requirements for the created slice. An additional attribute includes an IsolationSelectionList, which can be used by the slice consumer and service producer to select a desired Isolation Group. The IsolationSeclectionList is, in examples, a list with IsolationSelectionType and IsolationSelectionValue attributes that can be used by the slice consumer to specify a composite condition for selection of an Isolation Group for a requested network slice. The IsolationSelectionType attribute can indicate a “type”. For example, allowed “types” may include a groupType, groupName, groupTypeldentifier, identifier and IsolationLevel. In examples, the IsolationSelectionValue attribute indicates a “value” corresponding to a “type” specified in the IsolationSelectionType attribute.

During network slice life cycle management procedures, the slice consumer can transmit a request to a service producer to create or update a network slice. The slice consumer can further provide the IsolationSelectionList attribute in the network slice request, which can be used by the service provider to identify and/or select an appropriate Isolation Group. The service provider can create a network slice instance for the requested network slice and associate the network slice instance with the selected Isolation Group. For example, the service provider may associate the selected Isolation Group, and hence the isolation requirements, to the network slice instance and implement the isolation requirements during network slice creation. The service producer can then transmit information of the network slice instance to the slice consumer.

According to some examples, the slice consumer may be a Network Slice Consumer (NSC), Network Slice Management Service Consumer (NSMS_C), a Network Slice Subnet Consumer (NSSC) or a Network Slice Subnet Management Service Consumer (NSSMS_C). According to some further examples, the service producer may be a Network Service Provider (NSP), Network Slice Management Service Provider (NSMS_P), a Network Slice Subnet Provider (NSSP) or a Network Slice Subnet Management Service Provider (NSSMS_P). According to some further examples, the term “network slice” may comprise a full network slice or a network slice subnet. In some examples, a network slice subnet represents a group of network functions (including their corresponding resources) that form part or complete constituents of a network slice. According to some further examples, a network slice instance may comprise a network slice instance or a network slice subnet instance. In some examples, the network slice subnet instance forms part of the overall network slice instance.

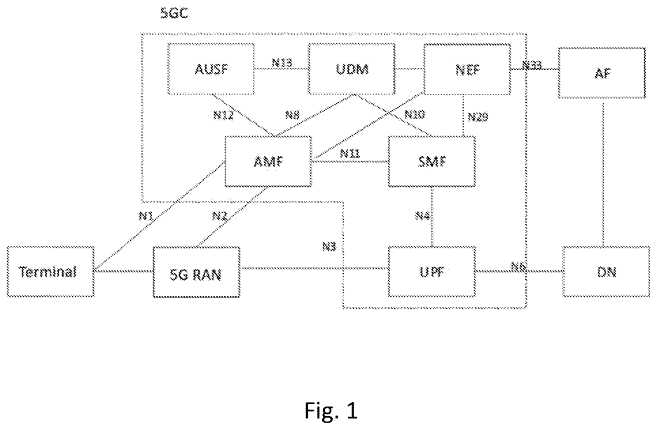

In some examples, as shown in FIG. 2, the service consumer is a NSC 200 and the service producer is a NSP 202.

In this example, at S201, the NSP 202 receives a request from a NSC 200 to create or update a network slice. The request may comprise an IsolationSelectionList.

At S202, the NSP 202 identifies and/or determines an appropriate Isolation Group for the network slice requested by the NSC 200 based on the IsolationSelectionList. For example, determining an Isolation Group may comprise selecting and/or creating an Isolation Group.

At S203, the NSP 202 associates a network slice instance with the selected Isolation Group. For example, the NSP 202 may associate the determined Isolation Group, and hence the isolation requirements, to the network slice instance and implement the isolation requirements during network slice creation.

At S204, the NSP 202 transmits information of the network slice instance to the NSC 200.

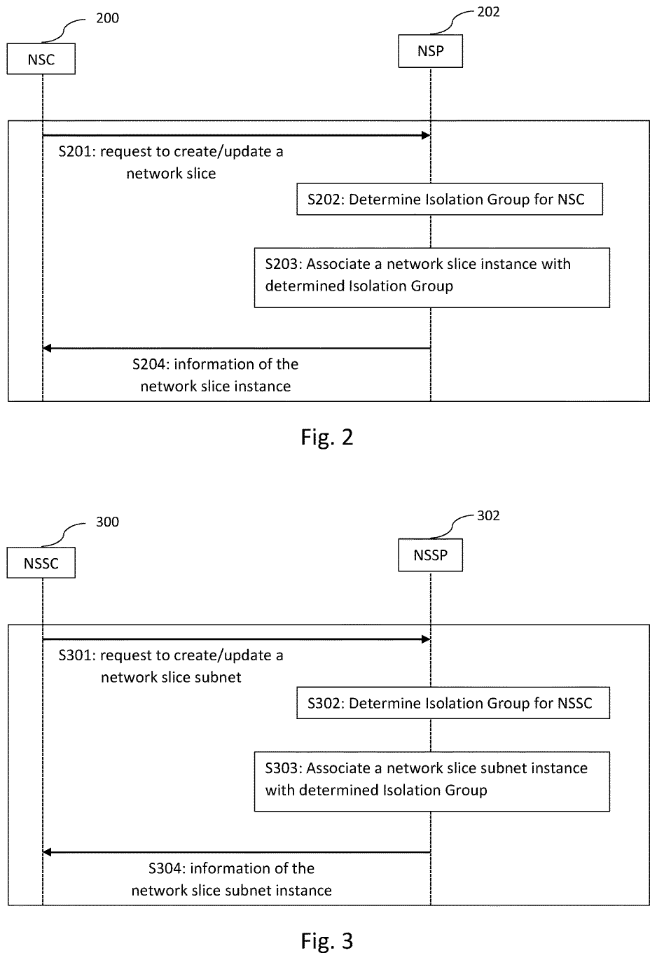

In other examples, as shown in FIG. 3, the slice consumer may be a NSSC 300 and the service producer may be a NSSP 302.

In this example, at S301, a NSSP 302 receives a request from the NSSC 300 to create or update a network slice subnet. The request may comprise an IsolationSelectionList.

At S302, the NSSP 302 uses the IsolationSelectionList to identify and/or determine an appropriate Isolation Group for the network slice subnet requested by the NSSC 300. For example, determining an Isolation Group may comprise selecting and/or creating an Isolation Group.

At S303, the NSSP 302 associates a network slice subnet instance with the determined Isolation Group. For example, the NSSP 302 may associate the selected Isolation Group, and hence the isolation requirements, to the network slice subnet instance and implement the isolation requirements during network slice subnet creation.

At S304, the NSSP 302 transmits information of the network slice subnet instance to the NSSC 300.

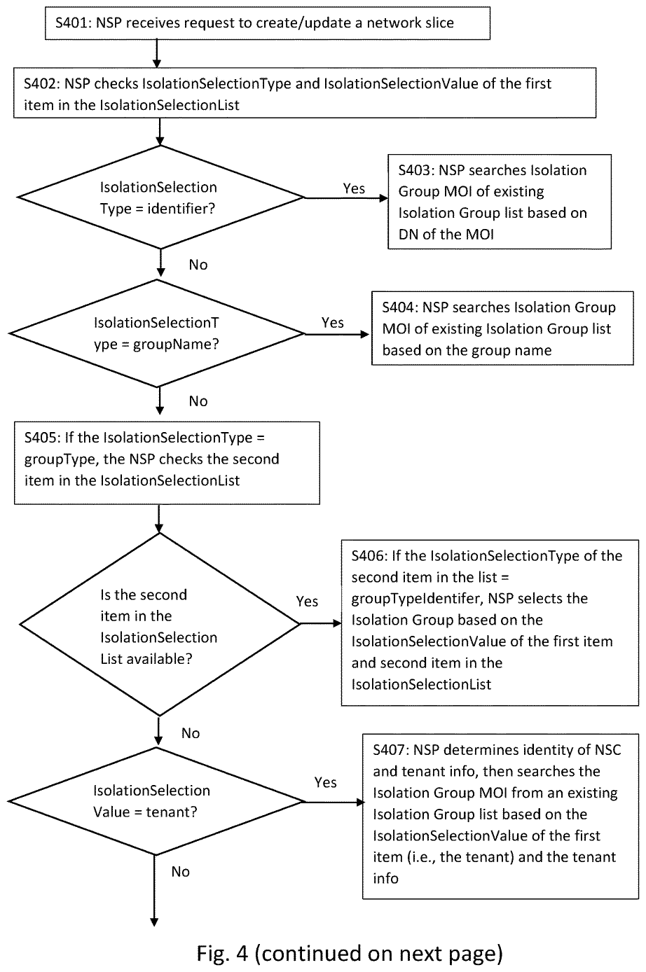

FIG. 4 shows a procedure for a NSP to identify and/or determine an Isolation Group for a NSC based on an IsolationSelectionList.

At S401 of the procedure, the NSP receives a request to create or update a network slice from a NSC. In examples, the request comprises a ServiceProfile with attributes. An attribute of the ServiceProfile may include an IsolationSelectionList attribute.

At S402 the NSP checks the IsolationSelectionType and IsolationSelectionValue of the first item in the IsolationSelectionList.

At S403, when the IsolationSelectionType is an identifier the IsolationSelectionValue contains the Distinguished Name (DN) of the Isolation Group MOI. The NSP then searches the Isolation Group Managed Object Instance (MOI) from an existing Isolation Group list based on the DN of the MOI.

At S404, when the IsolationSelectionType is a groupName, the IsolationSelectionValue contains the specific group name of an Isolation Group. The NSP then searches the Isolation Group MOI from an existing Isolation Group list based on the group name.

At S405, when the IsolationSelectionType is a groupType, the IsolationSelectionValue contains the specific group type of an Isolation Group. The NSP then checks the second item in the IsolationSelectionList.

At S406, when the second item is available and the IsolationSelectionType of the second item in the list is a groupTypeIdentifer, the IsolationSelectionValue of the second item contains the specific group type identifier of an Isolation Group. The NSP then selects the Isolation Group based on the IsolationSelectionValue of the first item and second item in the IsolationSelectionList. The IsolationSelectionValue of the first item may include a tenant, Slice/Service Type (SST), NSC, etc. In some examples, a tenant may be a communication service customer (CSC).

At S407, when the second item is not available and the IsolationSelectionValue of the first item is a tenant, the NSP determines the identity of the NSC from the network slice request received from the NSC. In some examples the identity of the NSC may be determined as part of an authentication and authorisation procedure. The NSP determines tenant information, e.g., the tenant id, based on the determined NSC identity. The NSP then searches the Isolation Group MOI from an existing Isolation Group list based on the IsolationSelectionValue of the first item (i.e., a tenant) and the tenant information.

At S408, when the second item is not available and the IsolationSelectionValue of the first item is the NSC, the NSP determines the identity of the NSC from the network slice request received from the NSC and searches the Isolation Group MOI from an existing Isolation Group list based on the IsolationSelectionValue of the first item (i.e., the NSC) and the NSC id.

At S409, when the second item is not available and the IsolationSelectionValue of the first item is a SST, the NSP determines the SST value either directly from the ServiceProfile or Single-Network Slice Selection Assistance Information (S-NSSAI) in the network slice request received from the NSC. The NSP searches the Isolation Group MOI from an existing Isolation Group list based on the IsolationSelectionValue of the first item (i.e., the SST) and the SST value.

In some examples, Isolation Groups may be pre-configured in the NSP. An NSC requesting a network slice from an NSP can specify a composite condition for selection of an Isolation Group. For example, the NSC can do this using the IsolationSelectionList. The NSP can then identify and/or select a pre-configured Isolation Group to be associated with the requested network slice. In some examples, if the NSC sends a network slice request to the NSP comprising an IsolationSelectionList specifying a particular IsolationSelectionType and IsolationSelectionValue, the NSP can identify and/or select a pre-configured Isolation Group which has the same characteristics of the received IsolationSelectionType and IsolationSelectionValue.

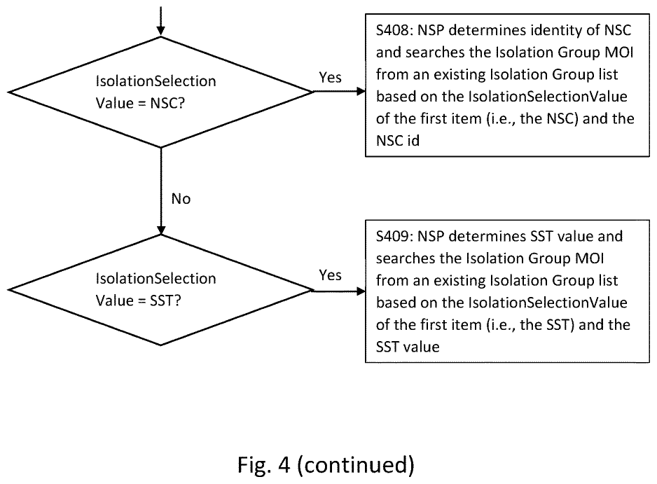

FIG. 5 shows example pre-configured Isolation Groups 1, 2, 3 and 4. Referring to the Isolation Groups of FIG. 5, when the NSC sends a network slice request to the NSP comprising an IsolationSelectionList specifying the IsolationSelectionType as “groupName” and the IsolationSelectionValue as “Isolation for FactoryA class 1”, the NSP can identify IsolationGroup-1 to be associated with the requested network slice. In some examples, “FactoryA” may be the communication service customer (CSC) that is requesting a network slice. For example, a CSC may be a company or the like. Similarly, if the NSP receives an IsolationSelectionList whereby the first item in the list specifies the IsolationSelectionType as “groupType” and the IsolationSelectionValue as “Tenant”, and the second item in the IsolationSelectionList specifies the IsolationSelectionType as “groupTypeIdenitifer” and the IsolationSelectionValue as “FactoryA”, the NSP could also identify IsolationGroup-1 to be associated with the requested network slice.

However, if, for example, the NSC sends the NSP a network slice request comprising an IsolationSelectionList whereby the first item in the list specifies the IsolationSelectionType as “groupType” and the IsolationSelectionValue as “NSC”, and the second item in the list specifies the IsolationSelectionType as “groupTypeldentifier” and the IsolationSelectionValue as “FactoryA”, the NSP can identify and/or select IsolationGroup-4 to be associated with the requested network slice.

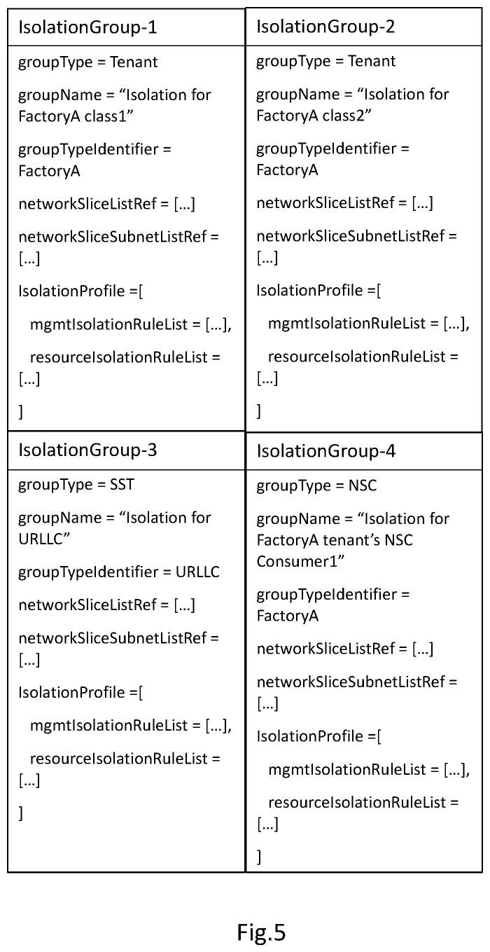

An entity such as a Network Operator (NOP), or an administrator user, may create Isolation Groups in the NSP. FIG. 6 shows a sequence diagram between an NOP 600 and an NSP 602.

At S601 the NOP 600 creates an Isolation Group request and transmits the request to the NSP 602. For example, the Isolation Group request may contain the Isolation Group attributes and/or may be an MOI Isolation Group request. In examples, the Isolation Group request comprises one or more attributes. For example, the one or more attributes may include one or more of: an IsolationProfile attribute; a groupType attribute; a groupTypeldentifier attribute; a groupName attribute; an identifier attribute.

At S602, the NSP 602 validates the Isolation Profile. The NSP 602 then creates an Isolation Group accordingly.

At S603, the NSP 602 creates an Isolation Group response. The NSP 602 then transmits this response to the NOP 600. For example, the Isolation Group response may be a Distinguished Name (DN) of the Isolation Group and/or an MOI Isolation Group response. This process occurs on a loop until all Isolation Groups are created in the NSP 602.

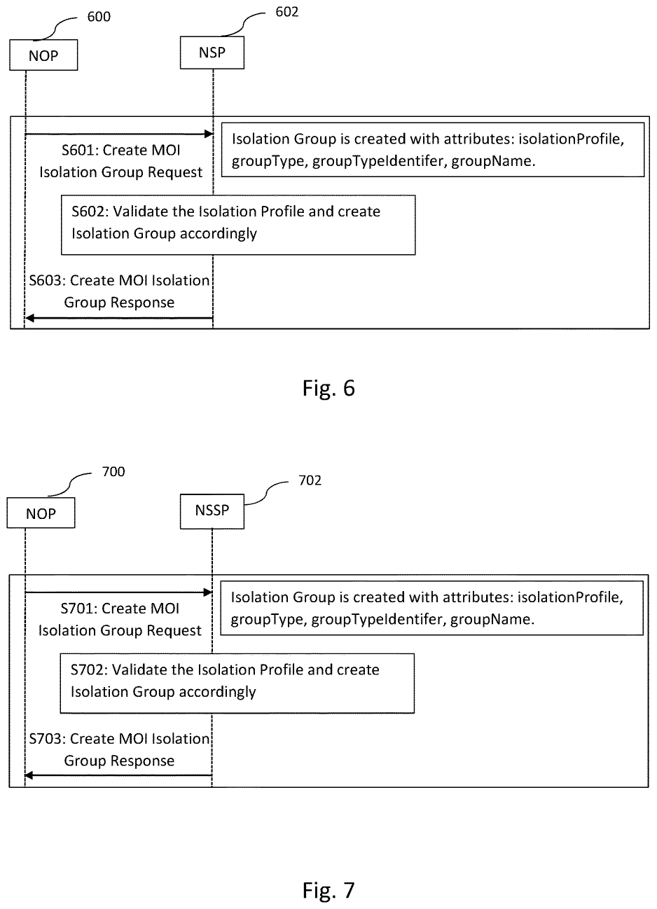

The NOP may also create Isolation Groups in the NSSP. FIG. 7 shows a sequence diagram between an NOP 700 and NSSP 702.

At S701 the NOP creates an Isolation Group request and sends this request to the NSSP 702. For example, the Isolation Group request may contain the Isolation Group attributes and/or may be an MOI Isolation Group request. In examples, the Isolation Group request comprises one or more attributes. For example, the one or more attributes may include one or more of: an IsolationProfile attribute; a groupType attribute; a groupTypeldentifier attribute; a groupName attribute; an identifier attribute.

At S702, the NSSP 702 validates the Isolation Profile. The NSSP 702 then creates an Isolation Group accordingly.

At S703, the NSSP 702 creates an Isolation Group response. The NSSP 702 then transmits this response to the NOP 700. For example, the Isolation Group response may be an MOI Isolation Group response and/or a DN of the Isolation Group. This process occurs on a loop until all Isolation Groups are created in the NSSP 702.

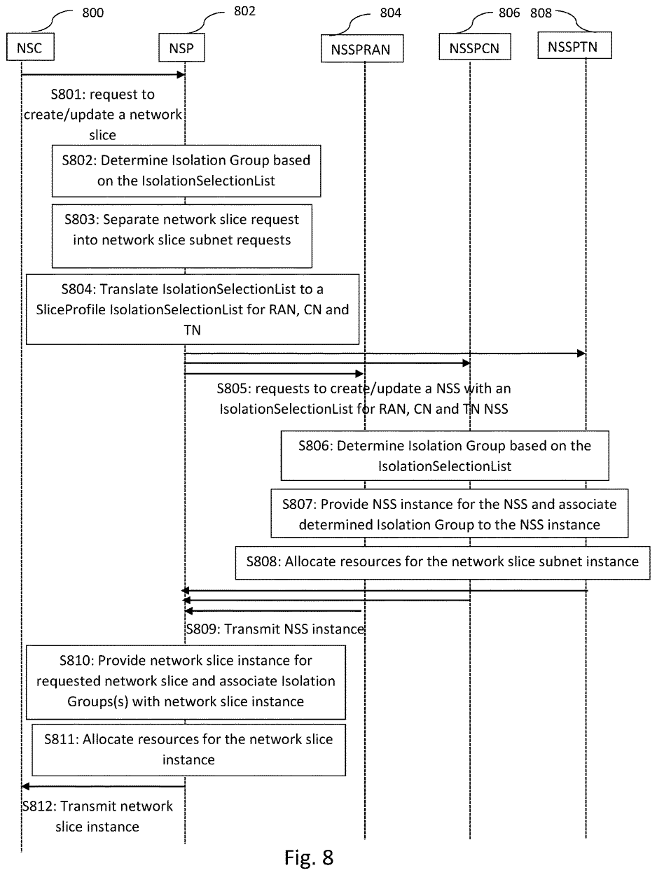

FIG. 8 shows a sequence diagram between a NSC 800, NSP 802, NSSPRAN 804, NSSPCN 806 and NSSPTN 808. The sequence diagram shows a mechanism for determining Isolation Group(s) for a requested network slice, with appropriate isolation requirements.

At S801, the NSC 800 transmits a request to create or update a network slice to the NSP 802. The request may comprise a ServiceProfile datatype with an IsolationSelectionList attribute which may enable the NSC 800 to specify a composite condition for selection of an Isolation Group to the NSP 802.

At S802, the NSP 802 identifies and/or determines an Isolation Group with the desired isolation requirements specified in the IsolationSelectionList. For example, determining an Isolation Group may comprise selecting and/or creating an Isolation Group.

At S803, the NSP 802 separates the received network slice request into a plurality of network slice subnet request(s) according to the ServiceProfile. For example, the NSP may decompose the ServiceProfile into one or more SliceProfile(s).

At S804, the NSP 802 translates the IsolationSelectionList comprised in the network slice request to a SliceProfile IsolationSelectionList. The SliceProfile IsolationSelectionList may be for at least one of a radio-access network (RAN); core network (CN); transport network (TN).

At S805, the NSP 802 transmits a request(s) to create or update a network slice subnet (NSS). The network slice subnet request(s) can be transmitted to one or more of a RAN Network Slice Subnet Provider 804; CN Network Slice Subnet Provider 806; TN Network Slice Subnet Provider 808. The request(s) may comprise one or more of an RANSliceProfile; CNSliceProfile; TNSliceProfile. The RANSliceProfile may include an IsolationSelectionList attribute for a RAN network slice subnet (NSS), the CNSliceProfile may include an IsolationSelectionList attribute for the CN network slice subnet and the TNSliceProfile may include an IsolationSelectionList attribute for the TN network slice subnet.

At S806, at least one of the RAN NSSP 804, CN NSSP 806 and TN NSSP 808 identifies and/or selects an Isolation Group(s). The Isolation Group(s) may be determined based on the isolation requirements specified in the received IsolationSelectionList(s). For example, the RAN NSSP may determine an Isolation Group based on the IsolationSelectionList specified in the RANSliceProfile, and/or the CN NSSP may determine an Isolation Group based on the IsolationSelectionList specified in the CNSliceProfile and/or the TN NSSP may determine an Isolation Group based on the IsolationSelectionList specified in the TNSliceProfile.

At S807, at least one of the RAN NSSP 804, CN NSSP 806 and TN NSSP 808 provides a network slice subnet instance for the network slice subnet request. Providing a network slice subnet instance may comprise creating and/or updating a network slice subnet instance. For example, the RAN NSSP may provide a network subnet slice instance for the network slice subnet request received at the RAN NSSP and/or the CN NSSP may provide a network subnet slice instance for the network slice subnet request received at the CN NSSP and/or the TN NSSP may provide a network subnet slice instance for the network slice subnet request received at the TN NSSP. The selected Isolation Group(s) may be associated with the network slice subnet instance(s). For example, the Isolation Group determined by the RAN NSSP may be associated with the network slice subnet instance provided by the RAN NSSP, and/or the Isolation Group determined by the CN NSSP may be associated with the network slice subnet instance provided by the CN NSSP and/or the Isolation Group determined by the TN NSSP may be associated with the network slice subnet instance provided by the TN NSSP.

At S808, at least one of the RAN NSSP, CN NSSP and TN NSSP allocate resources for the associated network slice subnet instance(s). For example, the RAN NSSP may allocate resources for the network slice subnet instance provided by the RAN NSSP, and/or the CN NSSP may allocate resources for the network slice subnet instance provided by the CN NSSP and/or the TN NSSP may allocate resources for the network slice subnet instance provided by the TN NSSP. According to some examples, the resources for the network slice subnet instance(s) are allocated or reused based on the Isolation Profile(s) of the determined Isolation Group(s). The management data of the network slice subnet instance(s) are isolated based on the Isolation Profile(s) of the determined Isolation Group(s).

At S809, at least one of the RAN NSSP 804, CN NSSP 806 and TN NSSP 808 transmits information of the network slice subnet instance to the NSP 802. For example, the RAN NSSP may transmit information of the network slice subnet instance provided by the RAN NSSP, the CN NSSP may transmit information of the network slice subnet instance provided by the CN NSSP and the TN NSSP may transmit information of the network slice subnet instance provided by the TN NSSP.

At S810, the NSP 802 provides a network slice instance for the network slice request received from the NSC 800. For example, providing a network slice instance may comprise creating and/or updating a network slice instance The NSP 802 then associates the determined Isolation Groups(s) to the network slice instance.

At S811, the NSP 802 allocates resources for the network slice instance. According to some examples, the resources for the network slice instance are allocated or reused based on the Isolation Profile(s) of the determined Isolation Group(s). The management data of the network slice instance are isolated based on the Isolation Profile(s) of the determined Isolation Group(s).

At S812, the NSP 802 transmits information of the network slice instance to the NSC 800.

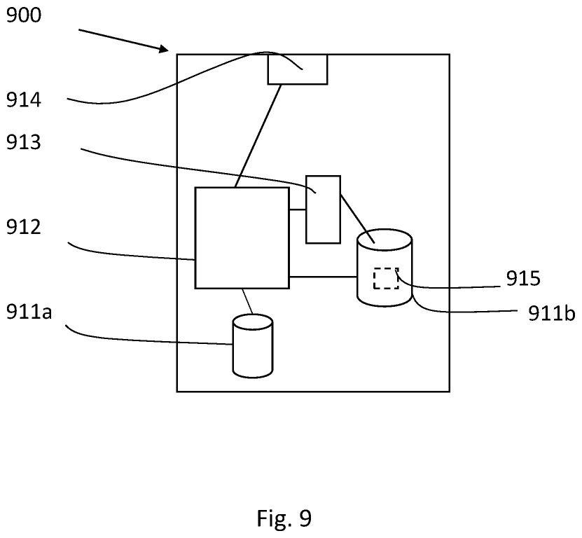

FIG. 9 illustrates an example of a control apparatus 900 for controlling a function of the 5GRAN or the 5GC as illustrated on FIG. 1. The control apparatus may comprise at least one random access memory (RAM) 911a, at least on read only memory (ROM) 911b, at least one processor 912, 913 and an input/output interface 914. The at least one processor 912, 913 may be coupled to the RAM 911a and the ROM 911b. The at least one processor 912, 913 may be configured to execute an appropriate software code 915. The software code 915 may for example allow to perform one or more steps to perform one or more of the present aspects. The software code 915 may be stored in the ROM 911b. The control apparatus 900 may be interconnected with another control apparatus 900 controlling another function of the 5GRAN or the 5GC. In some embodiments, each function of the 5GRAN or the 5GC comprises a control apparatus 900. In alternative embodiments, two or more functions of the 5GRAN or the 5GC may share a control apparatus.

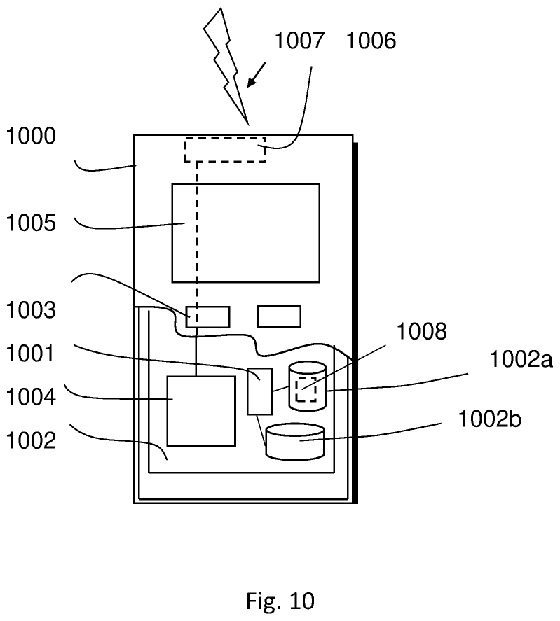

FIG. 10 illustrates an example of a terminal 1000, such as the terminal illustrated on FIG. 1. The terminal 1000 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 1000 may provide, for example, communication of data for carrying communications. The communications may be one or more of voice, electronic mail (email), text message, multimedia, data, machine data and so on.

The terminal 1000 may be provided with at least one processor 1001, at least one memory ROM 1002a, at least one RAM 1002b and other possible components 1003 for use in software and hardware aided execution of tasks it is designed to perform, including control of access to and communications with access systems and other communication devices. The at least one processor 1001 is coupled to the RAM 1002b and the ROM 1002a. The at least one processor 1001 may be configured to execute an appropriate software code 1008. The software code 1008 may for example allow to perform one or more of the present aspects. The software code 1008 may be stored in the ROM 1002a.

The processor, storage and other relevant control apparatus can be provided on an appropriate circuit board and/or in chipsets. This feature is denoted by reference 1004. The device may optionally have a user interface such as key pad 1005, touch sensitive screen or pad, combinations thereof or the like. Optionally one or more of a display, a speaker and a microphone may be provided depending on the type of the device.

The terminal 1000 may receive signals over an air or radio interface 1007 via appropriate apparatus for receiving and may transmit signals via appropriate apparatus for transmitting radio signals. In FIG. 10 transceiver apparatus is designated schematically by block 1006. The transceiver apparatus 1006 may be provided for example by means of a radio part and associated antenna arrangement. The antenna arrangement may be arranged internally or externally to the mobile device.

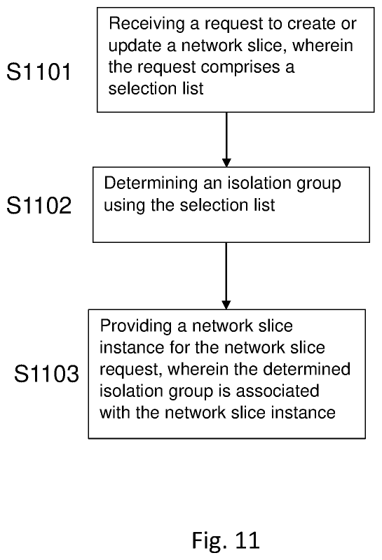

FIG. 11 is a flow chart of a method according to an example. The flow chart of FIG. 11 is viewed from the perspective of an apparatus. For example, the apparatus may comprise a Network Service Provider (NSP), Network Slice Management Service Provider (NSMS_P), a Network Slice Subnet Provider (NSSP) or a Network Slice Subnet Management Service Provider (NSSMS_P).

As shown at S1101 the method comprises receiving a request to create or update a network slice, wherein the request comprises a selection list. According to some examples, the term network slice may comprise a full network slice or a network slice subnet.

As shown at S1102, the method comprises determining an isolation group using the selection list.

As shown at S1103, the method comprises providing a network slice instance for the network slice request, wherein the determined isolation group is associated with the network slice instance. According to some examples, the network slice instance may comprise a network slice instance or a network slice subnet instance.

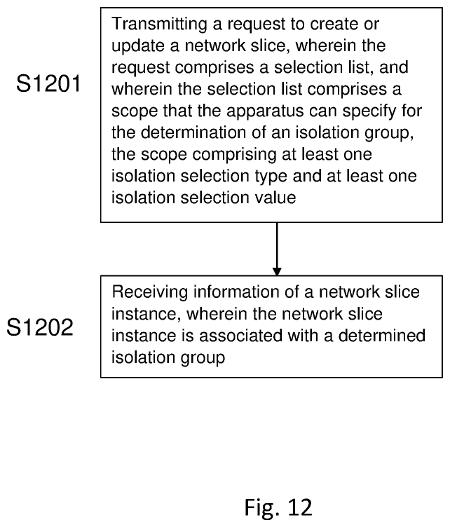

FIG. 12 is a flow chart of a method according to an example. The flow chart of FIG. 12 is viewed from the perspective of an apparatus. For example, the apparatus may comprise a Network Slice Consumer (NSC), Network Slice Management Service Consumer (NSMS_C), a Network Slice Subnet Consumer (NSSC) or a Network Slice Subnet Management Service Consumer (NSSMS_C).

As shown at S1201, the method comprises transmitting a request to create or update a network slice, wherein the request comprises a selection list, and wherein the selection list comprises a scope that the apparatus can specify for the determination of an isolation group, the scope comprising at least one isolation selection type and at least one isolation selection value. According to some examples, the term network slice may comprise a full network slice or a network slice subnet.

As shown at S1202, the method comprises receiving information of a network slice instance, wherein the network slice instance is associated with a determined isolation group. According to some examples, the network slice instance may comprise a network slice instance or a network slice subnet instance.

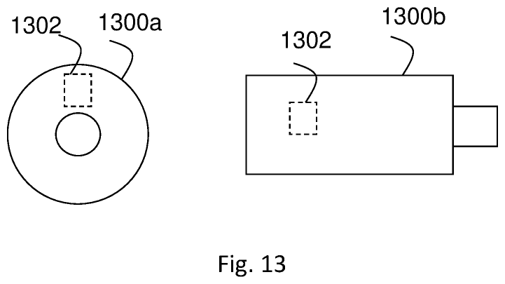

FIG. 13 shows a schematic representation of non-volatile memory media 1300a (e.g. computer disc (CD) or digital versatile disc (DVD)) and 1300b (e.g. universal serial bus (USB) memory stick) storing instructions and/or parameters 1302 which when executed by a processor allow the processor to perform one or more of the steps of the method of FIGS. 11 and 12.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory storing instructions which, when executed by the at least one processor, cause the apparatus to perform operations, the operations comprising:
receiving a request to create or update a network slice, wherein the request comprises a selection list;
determining an isolation group using the selection list; and
providing a network slice instance for the request, wherein the isolation group is associated with the network slice instance.

2. The apparatus of claim 1, wherein the selection list comprises a scope that a slice consumer can specify for the determining of the isolation group.

3. The apparatus of claim 2, wherein the scope comprises at least one isolation selection type and at least one isolation selection value.

4. The apparatus of claim 1, wherein the operations further comprise checking an isolation selection type and an isolation selection value of at least one of first and second items in the selection list.

5. The apparatus of claim 1, wherein the operations further comprise pre-configuring isolation groups in the apparatus, the isolation groups comprising the isolation group.

6. The apparatus of claim 5, wherein the pre-configuring the isolation groups in the apparatus comprises creating the isolation groups in the apparatus based on information from a network operator.

7. The apparatus of claim 1, wherein the operations further comprise allocating resources for the network slice instance based on an isolation profile of the isolation group.

8. The apparatus of claim 1, wherein the determining the isolation group comprises selecting a pre-configured isolation group or creating the isolation group.

9. The apparatus of claim 1, wherein the providing the network slice instance comprises creating a network slice instance or updating a network slice instance.

10. The apparatus of claim 1, wherein the isolation group comprises a group of network slices with the same isolation requirements for management and managed resources.

11. The apparatus of claim 1, wherein the operations further comprise:
translating the selection list to a slice profile selection list for at least one of a radio access network (RAN), a core network (CN) or a transport network (TN);
transmitting the slice profile selection list to at least one of a RAN network slice subnet provider, CN network slice subnet provider or TN network slice subnet provider, wherein the at least one of RAN network slice subnet provider, CN network slice subnet provider or TN network slice subnet provider uses the slice profile selection list to determine an isolation group; and
receiving information of a network slice subnet instance from the at least one of RAN network slice subnet provider, CN network slice subnet provider or TN network slice subnet provider, wherein the network subnet slice instance is associated with the isolation group determined by the at least one of RAN network slice subnet provider, CN network slice subnet provider or TN network slice subnet provider.

12-26. (canceled)

27. A non-transitory computer-readable medium comprising instructions, which when executed by an apparatus, cause the apparatus to perform at least the following:
receiving a request to create or update a network slice, wherein the request comprises a selection list;
determining an isolation group using the selection list; and
providing a network slice instance for the request, wherein the isolation group is associated with the network slice instance.

28. (canceled)

29. The non-transitory computer-readable medium of claim 27, wherein the selection list comprises a scope that a slice consumer can specify for the determining of the isolation group.

30. The non-transitory computer-readable medium of claim 29, wherein the scope comprises at least one isolation selection type and at least one isolation selection value.

31. The non-transitory computer-readable medium of claim 27, wherein the operations further comprise checking an isolation selection type and an isolation selection value of at least one of first and second items in the selection list.

32. The non-transitory computer-readable medium of claim 27, wherein the operations further comprise pre-configuring isolation groups in the apparatus, the isolation groups comprising the isolation group.

33. The non-transitory computer-readable medium of claim 32, wherein the pre-configuring the isolation groups in the apparatus comprises creating the isolation groups in the apparatus based on information from a network operator.

34. The non-transitory computer-readable medium claim 27, wherein the operations further comprise allocating resources for the network slice instance based on an isolation profile of the isolation group.

35. The non-transitory computer-readable medium of claim 27, wherein the determining the isolation group comprises selecting a pre-configured isolation group or creating the isolation group.

36. The non-transitory computer-readable medium of claim 27, wherein the providing the network slice instance comprises creating a network slice instance or updating a network slice instance.

37. The non-transitory computer-readable medium of claim 27, wherein the isolation group comprises a group of network slices with the same isolation requirements for management and managed resources.
